(19) United States
(12) Patent Application Publication
(10) Pub. No.: US 2007/0203042 A1
(43) Pub. Date: Aug. 30, 2007

(54) Composition for Dispersing of Particle, Composition Having Particle Dispersed Therein, Process for Producing the Same, and Sintered Compact of Anatase Titanium Oxide

(75) Inventors: Osamu Sakurada, Gifu (JP); Minoru Hashiba, Gifu (JP); Yasutaka Takahashi, Nara (JP); Tomokazu Ohya, Aichi (JP); Masaaki Saito, Gifu (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toyo Ink. Mfg. Co., Ltd., Tokyo (JP)

(21) Appl. No.: 10/593,294

(22) PCT Filed: Mar. 17, 2005
(86) PCT No.: PCT/JP05/04804

§ 371 Date: Jan. 3, 2007

(30) Foreign Application Priority Data
Mar. 18, 2004 (JP) 2004-079265

(51) Int. Cl. C11D 3/02

(52) U.S. Cl. 510/254

(57) ABSTRACT

The problems are to provide a composition for dispersing a particle that exhibits excellent dispersing effects as to various particle suspensions and leads no environmental loadings, a composition having a particle stably dispersed therein and a process for producing the same, and a sintered compact of anatase-type titanium oxide. The composition for dispersing of a particle of the present invention is characterized in being obtained by mixing a metal alkoxide containing a metal element having +3 to 5 valence (for example, titanium or the like), an organic acid (for example, lactic acid or the like) and water. The composition having a particle dispersed therein of the present invention is characterized in being comprising a particle (for example, an oxide particle or the like), the above composition for dispersing of a particle. The process for producing the composition having a particle dispersed therein of the present invention is characterized in comprising a mixing step of mixing the composition for dispersing of a particle, a particle and a solvent (for example, water or the like), wherein the amount of the composition to be mixed is adjusted depending on the isoelectric point of the particle.

### TECHNICAL FIELD

The present invention relates to a composition for dispersing of a particle, to a composition having a particle dispersed therein, to a process for producing the same, and to a sintered compact of anatase-type titanium oxide. More particularly, the present invention relates to a composition for dispersing of a particle exhibiting excellent dispersability to a suspension for various types of particles, and leading to no environmental loadings, to a composition having a particle dispersed stably therein, to a process for producing the same, and to a sintered compact of anatase-type titanium oxide.

The present invention is useful in a wide application for ceramic material, photocatalytic material, optical material, electronic material and the like.

### BACKGROUND ART

The dispersion containing a particle is mainly prepared by conventionally adjusting pH of a suspension and adding a dispersing agent in order to utilize electrostatic particle repulsion. As the dispersing agent, an inorganic electrolyte such as water glass and polyphosphoric acid, and a polymer electrolyte are commonly used. For the purpose of preparing a concentrated suspension in particular, it is considered difficult to adopt any action other than add a polymer electrolyte as the dispersing agent.

In colloidal chemistry, the presence of a polyvalent ion, even in a small quantity, is generally known to reduce the stability of a suspension. It has been assumed that the presence of an ion having high positive electric charge such as titanium (+4 valence) would lead to a dispersion having rapid aggregated.

Moreover, in the case of an aqueous solution containing an ion of a polyvalent metal such as titanium, an aqua complex ion readily undergoes hydrolysis and condensation due to the positive electric charge density and tends to precipitate out in the form of a basic oxide in general. And it is known that a stable aqueous solution containing an ion of a polyvalent metal cannot be obtained except under conditions of high acid concentration (e.g., U.S. Pat. No. 2,926,183).

### DISCLOSURE OF THE INVENTION

### Problems to be Solved by the Invention

As noted, it is not known that an aqueous solution containing an ion of a polyvalent metal such as titanium has effects on a suspension for a particle similar to the case using a polymer electrolyte as a dispersing agent.

The present invention was made with the foregoing in view, and has objects to provide a composition for dispersing of a particle exhibiting excellent dispersability to a suspension for various types of particles, and leading to no environmental loadings, a composition having a particle dispersed stably therein, a process for producing the same, and a sintered compact of anatase-type titanium oxide.

### MEANS FOR SOLVING PROBLEMS

The present inventors studied uses of a transparent and stable aqueous solution (composition) obtained by mixing a metal alkoxide such as titanium alkoxide, an organic acid such as lactic acid and water in detail, and discovered that a metal ion in the composition formed a complex with the organic acid, the complex was in the form of dissolved species being high bulk and having negative electrical charge, the functions as a dispersing agent were the same as or better than that of a polymer electrolyte reported to date, and the composition was extremely effective for dispersing various types of particles such as oxide particles when precipitate formation tests using ionic dyes, measurement of the zeta potential and the like were performed, to complete the present invention.

The present invention is as follows.

(1) A composition for dispersing of a particle, characterized in being obtained by mixing a metal alkoxide containing a metal element having +3 to 5 valence, an organic acid and water (hereinafter, referred to as “composition for dispersing a particle”).

(2) The composition for dispersing of a particle described in the above (1), which is obtained by mixing a hydrolysate derived from the aforementioned metal alkoxide, and the aforementioned organic acid, and which is a transparent aqueous solution.

(3) The composition for dispersing of a particle described in the above (1) or (2), wherein the aforementioned metal element is one element selected from the group consisting of aluminum, titanium, niobium and tantalum.

(4) The composition for dispersing of a particle described in the above (1) or (2), wherein the aforementioned metal element is aluminum or titanium.

(5) The composition for dispersing of a particle described in any one of the above (1) to (4), wherein the aforementioned organic acid is at least one type selected from the group consisting of lactic acid, oxalic acid, citric acid and tartaric acid.

(6) The composition for dispersing of a particle described in any one of the above (1) to (5), wherein the mixing proportion of the aforementioned organic acid and the aforementioned metal alkoxide (organic acid:metal alkoxide), is (0.5-2): 1 by molar ratio.

(7) A composition for dispersing of a particle, characterized in that the aforementioned composition is obtained by mixing a titanium alkoxide, at least one type of an organic acid selected from the group consisting of lactic acid, oxalic acid, citric acid and tartaric acid, and water; and that the mixing proportion of the aforementioned titanium alkoxide and the aforementioned organic acid (organic acid:titanium alkoxide), is (0.7-1.5):1 by molar ratio.

(8) A composition having a particle dispersed therein, characterized in comprising a particle and the aforementioned composition for dispersing of a particle described in any one of the above (1) to (7) (hereinafter, referred to as “particle-containing composition”).

(9) The composition having a particle dispersed therein described in the above (8), wherein the aforementioned particle is an oxide particle.

(10) The composition having a particle dispersed therein described in the above (8) or (9), wherein the content of the aforementioned particles is 60% by volume or less.

(11) The composition having a particle dispersed therein described in any one of the above (8) to (10), wherein pH is in the range from 2 to 11.

(12) The composition having a particle dispersed therein described in any one of the above (8) to (11), which is used in an application for ceramic material, photocatalytic material, optical material or electronic material.

(13) A composition having a particle dispersed therein, characterized in comprising an anatase-type titanium oxide particle and the aforementioned composition for dispersing of a particle described in the above (7).

(14) A sintered compact of anatase-type titanium oxide, characterized in that the solid fraction of the aforementioned composition having a particle dispersed therein described in the above (13) is sintered.

(15) The sintered compact of anatase-type titanium oxide described in the above (14), wherein the sintering temperature is in the range from 300 to 750° C.

(16) The sintered compact of anatase-type titanium oxide described in the above (14) or (15), which is used in an application for photocatalytic material or solar cell material.

(17) A process for producing a composition having a particle dispersed therein, characterized in that the aforementioned process comprises a mixing step for mixing the aforementioned composition for dispersing of a particle described in the above (1) to (7), a particle and a solvent, and that the amount of the aforementioned composition to be mixed is adjusted depending on the isoelectric point of the aforementioned particle in the aforementioned mixing step.

(18) The process for producing a composition having a particle dispersed therein described in the above (17), wherein the aforementioned solvent is water.

### EFFECTS OF THE INVENTION

According to the composition for dispersing of a particle of the present invention, it has excellent dispersability to a suspension for various types of particles and leads to no environmental loadings, and is useful in a wide application for ceramic material, photocatalytic material, optical material, electronic material and the like.

In addition, in the case of using a specific metal element, a composition for dispersing of a particle having excellent dispersability to a suspension for various types of particles can be obtained with higher reliability. Further, when a metal element which is the same species as the particle to be dispersed (for example, the case where the particle to be dispersed is a titanium oxide particle, and the metal element in the composition for dispersing of a particle is titanium), a particle-containing composition having fewer impurities can be obtained. When a metal element of a different base from that of the particle to be dispersed is used, it is possible to dope the particle in a desired proportion, for use in an application for electronic material and the like.

Further, in the case where the aforementioned organic acid and the aforementioned metal alkoxide are combined in specific proportions, a composition having excellent dispersability to a suspension for various types of particles, as well as being transparent and sufficiently stable.

According to another composition for dispersing of a particle of the present invention, since a titanium alkoxide and a specific organic acid are comprising in specific mixture proportions, the content of the titanic acid is high, the composition has excellent dispersability to a suspension for various types of particles and leads to no environmental loadings, it is useful in a wide application for ceramic material, photocatalytic material, optical material, electronic material and the like.

The particle-containing composition of the present invention is useful in a wide application for ceramic material, photocatalytic material, optical material, electronic material and the like, since a particle is stably dispersed by means of the composition for dispersing of a particle of the present invention.

Another particle-containing composition of the present invention comprises an anatase-type titanium oxide particle and a specific composition for dispersing of a particle, and the aforementioned titanium oxide particle is dispersed stably therein, therefore the composition is suitable for use in application for photocatalytic material, solar cell material and the like.

According to the sintered compact of anatase-type titanium oxide of the present invention, it is free from impurities due to the fact that the titanic acid in the aforementioned composition for dispersing of a particle becomes titanium oxide, titanium oxide derived from this titanic acid is present uniformly around the anatase-type titanium oxide particle and functions as a sintering aid among the particles. Therefore, if it is sintered at low temperature, for example in the range from 300 to 750° C., a sintered compact of anatase-type titanium oxide having high strength can be obtained. So it is suitable for use in an application for photocatalytic material, solar cell material such as dye sensitized solar cell.

According to the process for producing a particle-containing composition of the present invention, a particle-containing composition having a particle dispersed stably therein can be produced easily.

Additionally, in the case Where the solvent is water, the composition is easy to handle, and has no risk of fire, making it highly safe.

### BRIEF DESCRIPTION OF DRAWINGS

FIG. 1 is an explanatory diagram showing the results of precipitate formation tests with dyes.

FIG. 2 is a graph showing the relationship of pH and zeta potential in 2-vol % aluminum oxide suspensions having various titanic acid concentrations.

FIG. 3 is a graph showing the relationship of titanic acid concentration and zeta potential in 2-vol % aluminum oxide suspensions having various pHs.

FIG. 4 is a graph showing the relationship of titanic acid concentration, sedimentation volume and sedimentation rate in a 2-vol % aluminum oxide suspension having pH2.

FIG. 5 is a graph showing the relationship of titanic acid concentration, sedimentation volume and sedimentation rate in a 2-vol % aluminum oxide suspension having pH4.

FIG. 6 is a graph showing the relationship of titanic acid concentration, sedimentation volume and sedimentation rate in a 2-vol % aluminum oxide suspension having pH10.5.

FIG. 7 is a graph showing the relationship of titanic acid concentration and apparent viscosity in a 2-vol % aluminum oxide suspension having pH4.

FIG. 8 is a graph showing the relationship of titanic acid concentration and apparent viscosity in a 20-vol % aluminum oxide suspension having pH4.

FIG. 9 is a graph showing the relationship of titanic acid concentration and apparent viscosity in a 2-vol % aluminum oxide suspension having pH10.5.

FIG. 10 is a graph showing the relationship of titanic acid concentration and apparent viscosity in a 20-vol % aluminum oxide suspension having pH10.5.

FIG. 11 is a graph showing the relationship of shear stress and shear rate in a 20-vol % aluminum oxide suspension having pH4.

FIG. 12 is a graph showing the relationship of shear stress and shear rate in a 20-vol % aluminum oxide suspension having pH10.5.

FIG. 13 is a graph showing the relationship of titanic acid concentration and absorbed amount of titanium in a 2-vol % aluminum oxide suspension having pH4.

FIG. 14 is a graph showing the relationship of titanic acid concentration and absorbed amount of titanium in a 2-vol % aluminum oxide suspension having pH9.

FIG. 15 is a graph showing the relationship of titanic acid concentration and absorbed amount of titanium in a 2-vol % aluminum oxide suspension having pH10.5.

FIG. 16 is a graph showing the change in dispersability at various ratios of titanium alkoxide and lactic acid in a 2-vol % aluminum oxide suspension having pH10.5.

FIG. 17 is a graph showing the change in dispersability at various ratios of titanium alkoxide and lactic acid in a 2-vol % aluminum oxide suspension having pH10.5.

FIG. 18 is a graph showing the change in dispersability at various ratios of titanium alkoxide and lactic acid in a 2-vol % aluminum oxide suspension having pH2.

FIG. 19 is a graph showing the change in dispersability at various ratios of titanium alkoxide and lactic acid in a 2-vol % aluminum oxide suspension having pH2.

### BEST MODE FOR CARRYING OUT THE INVENTION

The invention will now be described in further detail.

[1] Composition in Order to Disperse a Particle Therein (Composition for Dispersing a Particle)

The composition for dispersing a particle of the present invention is characterized in being obtained by mixing a metal alkoxide containing a metal element having +3 to 5 valence, an organic acid and water.

In addition, this composition for dispersing a particle can be one which is obtained by mixing a hydrolysate derived from the aforementioned metal alkoxide and the aforementioned organic acid, and which is a transparent aqueous solution.

The aforementioned composition for dispersing a particle is thought to be a metal acid aqueous solution in which a metal ion (mainly a metal acid ion) has formed a complex with the organic acid, and this stable metal complex having a high bulk and negative electrical charge is present in the aqueous solution.

The aforementioned “organic acid” includes, for example, lactic acid, oxalic acid, citric acid, tartaric acid and the like. These organic acids may be used alone or in combination of two or more.

The aforementioned “metal alkoxide” contains a metal element having +3 to 5 valence. This metal alkoxide can be represented as [M(OR)ₓ] (where M denotes a metal element having +3 to 5 valence; R is an alkyl group; x is an integer from 3 to 5 and is corresponding to the valence of the metal element (M)).

Example of the aforementioned metal element (M) includes aluminum, gallium, indium, titanium, hafnium, vanadium, niobium, tantalum and the like. Of these, aluminum, titanium, niobium and tantalum are preferred, with aluminum and titanium being especially preferred, and titanium being further preferred.

The aforementioned alkyl group (R) is typically an alkyl group having a carbon number of 1 to 8, preferably 1 to 6, and more preferably 1 to 4. Specific example includes methoxide, ethoxide, propoxide, isopropoxide, butoxide and the like. In the case where this alkyl group is butoxide, an alcohol content (butanol) to be formed in hydrolysis of the metal alkoxide is separated, therefore, a composition containing alcohol in less content can be prepared without treating such as distillation under the reduced pressure.

These metal alkoxides may be used alone or in combination of two or more.

Specific example of the titanium alkoxide when the metal element is titanium includes titanium tetramethoxide [Ti(O-Me)₄], titanium tetraethoxide [Ti(O-Et)₄], titanium tetraisopropoxide [Ti(O-iPr)₄], titanium tetrabutoxide [Ti(O-Bu)₄] and derivatives of these, and the like. Of these, titanium tetraisopropoxide and titanium tetrabutoxide are preferred from the viewpoint of easy obtaining and handling. In addition, titanium tetrabutoxide is preferred from the viewpoint of easy eliminating an alcohol content formed by hydrolysis.

Further, specific example of the aluminum alkoxide in the case where the aforementioned metal element is aluminum includes aluminum trimethoxide [Al(O-Me)₃], aluminum triethoxide [Al(O-Et)₃], aluminum triisopropoxide [Al(O-iPr) 3], aluminum tributoxide [Al(O—Bu)₃], and derivatives of these, and the like. Of these, aluminum triisopropoxide and aluminum tributoxide are preferred from the viewpoint of easy obtaining and handling. In addition, aluminum tributoxide is preferred from the viewpoint of easy eliminating an alcohol content formed by hydrolysis.

In the case of performing the aforementioned “mixing”, the order in mixing the aforementioned metal alkoxide, the aforementioned organic acid and water is not particularly limited and includes, for example, (1) mixing the metal alkoxide, the organic acid and water simultaneously, (2) mixing the metal alkoxide and the organic acid, and then mixing with water, and (3) mixing the metal alkoxide and water, and then mixing with the organic acid. In each of these cases, the metal alkoxide is subjected to hydrolysis in the presence of water to initially become milky, and subsequently the hydrolysate derived from the metal alkoxide is dissolved by mixing with the organic acid to form a transparent liquid. It is noted that the composition for dispersing a particle of the present invention may be obtained in the form of a transparent liquid by means of stirring for one week or more, especially 2 to 6 weeks and ideally 2 to 4 weeks after being initially mixed, or obtained in the form of a transparent liquid without the aforementioned stirring.

Atmosphere and temperature in performing the aforementioned mixing are not particularly limited, and the mixing may be carried out at room temperature (about 25° C.) in air, for example. Additionally, atmosphere and temperature in performing the aforementioned stirring are not particularly limited, and the stirring may be carried out at room temperature (about 25° C.) in air, for example.

The mixing proportion of the aforementioned organic acid and the aforementioned metal alkoxide (organic acid:metal alkoxide) is not particularly limited. For example, the molar ratio can be (0.5-4):1, preferably (0.5-3):1, more preferably (0.5-2):1, further preferably (0.5-1.8):1, yet more preferably (0.7-1.5):b 1 and particularly 1:1. When this ratio is (0.5-4):1, a composition exhibiting excellent dispersability to a suspension for various types of particles and being transparent and sufficiently stable, is obtained. Where the proportion is 1:1 in particular, a composition in which a metal component of a prescribed metal alkoxide is contained in high concentration can be easily obtained. Moreover, increasing the proportion of the aforementioned metal alkoxide leads to an improved dispersability. On the other hand, increasing the proportion of the aforementioned organic acid makes stirring period short.

Further, the composition for dispersing a particle of the present invention may be one which is obtained by mixing the aforementioned titanium alkoxide, at least one type of an organic acid selected from the group consisting of lactic acid, oxalic acid, citric acid and tartaric acid, and water; and wherein the mixing proportion of the titanium alkoxide and the organic acid (organic acid:titanium alkoxide), is (0.7-1.5):1 (preferably 1:1) by molar ratio. In this case, a composition for dispersing a particle containing titanic acid in high concentration of preferably 1 to 3 mol/dm³, more preferably 1 to 2.5 mol/dm³ and especially 1.5 to 2.5 mol/dm³, and having excellent dispersability of the particle can be obtained.

The amount of the aforementioned “water” to be mixed is not particularly limited, and may be adjusted appropriately so as to take a prescribed concentration of the metal component in the composition for dispersing a particle of the present invention. This water to be used is not particularly limited, it is possible to use purified water, distilled water and the like.

The concentration of the metal component in the composition for dispersing a particle of the present invention is not particularly limited, and may be adjusted appropriately according to the intended application, purpose and the like.

In addition, the composition for dispersing a particle of the present invention contains an alcohol content formed by hydrolysis of the metal alkoxide due to the nature of the production process, however, this alcohol content can be eliminated by some known method (e.g., vacuum distillation or the like) if necessary. It is noted that elimination of the alcohol content formed by hydrolysis does not diminish homogeneity, stability and dispersability of the particle in the composition in any way.

Moreover, this composition for dispersing a particle can maintain the state of a homogenous solution for an indefinite period (typically one year or more, especially 1 to 10 years), with substantially no gelation or precipitation.

Thus obtained composition for dispersing a particle of the present invention is a transparent (colorless and transparent in particular) and a stable liquid having pH in the range from 1 to 12. Additionally the composition is a transparent and stable liquid having pH in the range from 1 to 11 (especially pH from 2 to 11), and can stably disperse a prescribed particle.

Further, the composition for dispersing a particle of the present invention is preferably one capable of forming a precipitate when the composition is reacted with a cationic dye used in the “precipitate formation test” which shall be described later in Examples.

Since the composition for dispersing a particle of the present invention has excellent dispersability to a suspension for various types of particles and leads to no environmental loadings, it can be industrially applied at ease, and is useful in a wide application for ceramic material, photocatalytic material, optical material, electronic material and the like. Further, since the composition does not contain other components such as halogens, nitric acid and sulfuric acid, there is no impact on the environment when the composition undergoes the sintering process. And since the composition is an aqueous solution, risk of fire and the like is absent, and safety is excellent.

Additionally, in regard to this composition for dispersing a particle, if solids obtained by eliminating water, or water and alcohols in the composition are re-dissolved in water, the solution can be used as the composition for dispersing a particle of the present invention. In such a case, dispersability similar to that described above can be obtained.

[2] Composition Having a Particle Dispersed Therein (Particle-Containing Composition)

The particle-containing composition of the present invention is characterized in comprising a particle and a composition for dispersing a particle. Regarding this “composition for dispersing a particle”, the explanation in [1] above can be applied as it is.

The aforementioned “particle” is not particularly limited and can be either an inorganic particle or an organic particle.

The aforementioned inorganic particle includes, for example, a particle composed of (1) an oxide such as aluminum oxide, titanium oxide, zirconium oxide, silicon oxide, magnesium oxide, iron oxide, zinc oxide, tin oxide, chromium oxide and ferrite; (2) a carbide such as titanium carbide, zirconium carbide, tungsten carbide, iron carbide and silicon carbide; (3) a nitride such as titanium nitride and iron nitride; (4) a hydroxide such as aluminum hydroxide and zirconium hydroxide; (5) a metal such as gold, platinum, silver and copper, and the like. Further, a salt such as calcium carbonate and beryllium carbonate, and a powder which is derived from natural minerals, and the like can be mentioned as well.

The aforementioned organic particle includes, for example, a resin particle composed of an acrylic-based resin, an amide-based resin, an ester-based resin, an epoxy-based resin, a melamine-based resin, an urethane-based resin, a styrene-based resin, a silicone-based resin and a fluorine-based resin (including an elastomer particle and a rubber particle). In addition, a starch powder, a cellulose powder and the like can be mentioned as well.

In the present invention, the type of the particle to be used can be appropriately selected according to the intended application, purpose and the like. These particles can be used alone or in combination of two or more types in consideration of the particle surface charge.

Moreover, the type of the particle can be an oxide particle or an organic particle, and can especially be an oxide particle in the present invention.

Further, the particle-containing composition can be one in which the aforementioned particle is a titanium oxide particle; and the aforementioned composition for dispersing a particle is one obtained by mixing a titanium alkoxide, at least one organic acid selected from the group consisting of lactic acid, oxalic acid, citric acid, and tartaric acid, and water, with the mixing proportion of the titanium alkoxide and the organic acid (organic acid:titanium alkoxide) being (0.7-1.5):1 by molar ratio in the present invention. In this case, since the composition for dispersing a particle capable of being a dispersion medium can contain titanic acid in high concentration, a suspension rich in a titanium component can be obtained. The alcohol content formed by hydrolysis of the titanium alkoxide may be eliminated by the method mentioned previously.

Additionally, the crystal form of the aforementioned titanium oxide particle is not particularly limited and may be any of anatase-type, rutile-type and brookite-type, but is preferably anatase-type. In the case this particle is anatase-type titanium oxide particle, the particle-dispersed composition can be suitably used in an application for photocatalytic material, solar cell material and the like.

The mean particle size of the aforementioned particle is not particularly limited, and may be adjusted appropriately according to the intended application, purpose and the like.

The concentration of the metal component in the particle-containing composition of the present invention can be adjusted appropriately according to the intended application, purpose and the like. The higher this concentration is, the more the surface charge of the dispersed particle tends to shift to the negative.

The proportion of the particle contained in the particle-containing composition of the present invention is not particularly limited, and is preferably 60% by volume or less, and more preferably 1 to 50% by volume, based on 100% by volume of the particle-containing composition. In the case where the content is 60% by volume or less, a composition in which the prescribed particle is more stably dispersed is obtained.

Additionally, the particle-containing composition of the present invention preferably has pH in the range from 1 to 12, more preferably pH from 1 to 11, and further more preferably pH from 2 to 11. When the pH is in the range from 2 to 11, a composition in which the prescribed particle is more stably dispersed is obtained.

The particle-containing composition of the present invention generally contains a solvent. This solvent includes (1) water such as purified water and distilled water, (2) a mixed liquid of water and a hydrophilic organic solvent, and the like. Example of this organic solvent includes, for example, a lower alcohol such as ethanol and isopropanol. Of these, water is preferred from the viewpoint of easy handling as well as high safety due to the absence of the risk of fire and the like.

Further, the particle-containing composition of the present invention may contain known additive according to the intended application, purpose and the like, unless stable dispersability of the particle is not reduced.

Moreover, since the particle-containing composition of the present invention uses the aforementioned composition for dispersing a particle, the composition leads to no environmental loadings and can be industrially applied at ease, and is useful in a wide application for ceramic material, photocatalytic material, optical material, electronic material and the like. Further, since the composition does not contain other components such as halogens, nitric acid and sulfuric acid, there is no impact on the environment when the composition undergoes the sintering process. And since the composition can be an aqueous-based, risk of fire and the like is absent, and safety is excellent.

Furthermore, when the particle-containing composition of the present invention is subjected to sintering process, a metal acid in the composition for dispersing a particle turns into a metal oxide, an oxide particle and the like are present uniformly around the dispersed particle and functions as a sintering aid among the particles. Thus, uniform doping of the aforementioned metal element having a valence of +3 to 5 among particles can be achieved.

[3] Process for Producing a Particle-Containing Composition

The process for producing a particle-containing composition of the present invention is characterized in that the process comprises a mixing step for mixing the composition for dispersing a particle, a particle and a solvent, and that the amount of the composition for dispersing a particle to be mixed is adjusted depending on the isoelectric point of the particle in the mixing step. Regarding the aforementioned “composition for dispersing a particle”, the explanation in [1] above can be applied as it is. Additionally, regarding the aforementioned “particle” and the aforementioned “solvent”, the explanation in [2] above can be applied as it is. And water is preferable in particular.

In the aforementioned “mixing step”, the composition for dispersing a particle, a particle and a solvent are subjected to mixing. The order in mixing the composition for dispersing a particle, the particle and the solvent is not particularly limited and these may be mixed simultaneously, or mixed while charging in any order. As a specific example, after the particle and the solvent are mixed, the composition for dispersing a particle is blended in.

The mixing means in the aforementioned “mixing step” is not particularly limited. A ball milling, an ultrasonic homogenizer and the like can be used for mixing.

Further, atmosphere and temperature in mixing are not particularly limited, and the mixing be carried out at room temperature (about 25° C.) in air, for example.

The amount of the aforementioned composition for dispersing a particle to be mixed is adjusted depending on the isoelectric point of the aforementioned particle. This composition for dispersing a particle can be used in the same manner as a conventional polymer electrolyte since pH behavior of the composition is very similar to pH behavior observed when an anionic polymer electrolyte is added as the dispersing agent.

For example, in the case a particle to be dispersed is of aluminum oxide (isoelectric point:close to pH9), since the surface of the aluminum oxide has positive charge in pH region to the acidic side against the isoelectric point (less than about pH9). Therefore, when the composition for dispersing a particle comprising a complex having negative charge is formulated, aggregation occurs. Further, increasing the amount of the composition for dispersing a particle to be formulated and mixing by use of the amount sufficient at least to neutralize the surface charge of the aluminum oxide lead to re-dispersion. For the purpose of dispersing a prescribed particle in pH region lower than the isoelectric point (acidic side) in this way, it is necessary to mix the composition for dispersing a particle in an amount more than the amount to neutralize the surface charge of the particle. In this case, a particle-containing composition that contains a large amount of the metal component can be produced, and it is useful in a wide application for ceramic material, photocatalytic material, optical material, electronic material and the like.

On the other hand, since the surface of the aluminum oxide has negative charge similar to that of the complex in the composition for dispersing a particle in pH region to the alkaline side against the isoelectric point (the case of exceeding about pH9), a more stably dispersed composition can be obtained without aggregation.

[4] Sintered Compact of Anatase-Type Titanium Oxide

The sintered compact of anatase-type titanium oxide of the present invention is characterized in that the solid fraction of a particle-containing composition which comprises a particle composed of anatase-type titanium oxide and a composition for dispersing a particle is sintered.

The mean particle size of the aforementioned “anatase-type titanium oxide particle” is not particularly limited, and can be adjusted appropriately according to the intended application, purpose and the like.

The proportion of the anatase-type titanium oxide particle contained is not particularly limited, but it is preferably 60% by volume or less, and more preferably 1 to 50% by volume, based on 100% by volume of the particle-containing composition, for example. When the content is 60% by volume or less, the particle is stably dispersed, being preferable.

The aforementioned “composition for dispersing a particle” is the aforementioned composition for dispersing a particle obtained by mixing a titanium alkoxide, at least one type of an organic acid selected from the group consisting of lactic acid, oxalic acid, citric acid and tartaric acid, and water; and that the mixing proportion of the aforementioned titanium alkoxide and the aforementioned organic acid (organic acid:titanium alkoxide), is (0.7-1.5):1 by molar ratio. In particular, the composition is preferably one in which an alcohol content formed by hydrolysis of the titanium alkoxide was eliminated according to the method mentioned previously. In this case, the composition becomes a titanic acid aqueous solution substantially devoid of superfluous components, and makes purity of the titanium component higher, being preferable.

The aforementioned “solid fraction of a particle-containing composition” can be obtained by drying the particle-containing composition according to an ordinary method.

The sintering temperature is generally in the range from 300 to 750° C., preferably from 400 to 750° C., and more preferably from 500 to 750° C. In the case the sintering temperature is within the above range, a sintered compact of anatase-type titanium oxide having strength can be obtained without transition of the titanium oxide particle to the rutile-type. In addition, a higher sintering temperature within the aforementioned range can improve the strength of the sintered compact.

The sintered compact of anatase-type titanium oxide of the present invention is having strength even if it is obtained by sintering at low temperature in the range from 300 to 750° C., since the titanic acid in the aforementioned composition for dispersing a particle is converted to titanium oxide and no impurities are incorporated, and the titanium oxide derived from this titanic acid is present uniformly around the anatase-type titanium oxide particle and functions as a sintering aid among the particles. It is therefore possible to produce a thin film of anatase-type titanium oxide and a thick bulk of anatase-type titanium oxide difficult to produce by conventional methods such as a sol-gel method, without the addition of superfluous components. And they are useful in a wide application for ceramic material, photocatalytic material, optical material, electronic material and the like. In particular, the sintered compact of anatase-type titanium oxide of the present invention can be used in an application for photocatalytic material or solar cell material such as dye-sensitized solar cells (e.g., panels, electrodes and the like).

### EXAMPLES

Hereinafter, the present invention will be described in detail using Example.

[1] Preparation of a Composition for Dispersing a Particle (Composition for Dispersing a Particle)

### Example 1

Titanium tetraisopropoxide (product of Wako Pure Chemical Industries Ltd.) and lactic acid (product of Wako Pure Chemical Industries Ltd.) were mixed so that the molar ratio (titanium tetraisopropoxide:lactic acid) was 1:1, and then mixed with water (purified water). When the water was added, the mixed solution immediately turned milky due to hydrolysis and became a solution having extremely high viscosity. After that, stirring was conducted for two weeks using a stirrer to obtain a colorless and transparent composition for dispersing a particle having low viscosity [metal component concentration (titanic acid concentration):2 mol/dm³].

When oxalic acid, citric acid, or tartaric acid (all products of Nacalai Tesque Inc.) was used instead of the aforementioned lactic acid, similar compositions for dispersing a particle were obtained. In addition, when titanium tetrabutoxide (product of Wako Pure Chemical Industries Ltd.) or aluminum triisopropoxide (product of Nacalai Tesque Inc.) was used instead of the aforementioned titanium tetraisopropoxide, compositions for dispersing a particle similar to that of Example 1 were also obtained successfully. Further, when the aforementioned molar ratio (titanium tetraisopropoxide:lactic acid) varied to 1:0.8 and to 1:0.9, compositions for dispersing a particle similar to that of Example 1 were also obtained. Moreover, when these composition for dispersing a particle were stored for long period (approximately one year), each of them maintained the state of uniform solution, with no gelation or precipitation.

### Example 2

Titanium tetraisopropoxide (product of Wako Pure Chemical Industries Ltd.) and water (purified water) were mixed together. At that time, the mixed solution immediately turned milky due to hydrolysis and became a solution having extremely high viscosity. After that, lactic acid (product of Wako Pure Chemical Industries Ltd.) was mixed in so that the molar ratio (titanium tetraisopropoxide:lactic acid) was 1:1. Subsequently, stirring was conducted for two weeks using a stirrer to obtain a colorless and transparent composition for dispersing a particle having low viscosity [metal component concentration (titanic acid concentration):2 mol/dm³].

When oxalic acid, citric acid, or tartaric acid (all products of Nacalai Tesque Inc.) was used instead of the aforementioned lactic acid, similar compositions for dispersing a particle were obtained. In addition, when titanium tetrabutoxide (product of Wako Pure Chemical Industries Ltd.) or aluminum triisopropoxide (product of Nacalai Tesque Inc.) was used instead of the aforementioned titanium tetraisopropoxide, compositions for dispersing a particle similar to that of Example 2 were also obtained successfully. Further, when the aforementioned molar ratio (titanium tetraisopropoxide:lactic acid) varied to 1:0.8 and to 1:0.9, compositions for dispersing a particle similar to that of Example 1 were also obtained. Moreover, when these composition for dispersing a particle were stored for long period (approximately one year), each of them maintained the state of uniform solution, with no gelation or precipitation.

[2] Properties of the Composition for Dispersing a Particle (Precipitate Formation Test with Dyes)

The composition for dispersing a particle of Example 1 obtained in [1] above was added to the dyes Nos. 1 through 5 listed below, so that the metal component and dye concentration was 0.001 mol/dm³ to perform precipitate formation test with dyes. The results are shown in FIG. 1.

No. 1: anionic dye; Methyl Orange (Junsei Kagaku Co. Ltd.)

No. 2: anionic dye; Fluorescein (Nacalai Tesque Inc.)

No. 3: cationic dye; Toluidine Blue (Chroma Gesellshaft Schmid Gmbh & Co.)

No. 4: cationic dye; Bindschedler's Green (Chroma Gesellshaft Schmid Gmbh & Co.)

No. 5: cationic dye; Capri Blue (Tokyo Chemical Industry Co. Ltd.)

According to FIG. 1, precipitates with the anionic dyes of Nos. 1 and 2 did not form among dyes to which the composition for dispersing a particle was added. On the other hand, formation of precipitates was confirmed in all of the cationic dyes Nos. 3 through 5.

From these results, it was confirmed in the composition for dispersing a particle of Example 1 that the metal acid ion (titanic acid ion) formed a complex with the organic acid (lactic acid), and a stable metal complex (titanium complex) having a negative charge was present in the aqueous solution. Further, if it does not show bulky, a precipitate is not formed, however, this metal complex was bulky and it is thought being present in cluster unit-like form containing titanium.

[3] Dispersability of the Composition for Dispersing a Particle

A composition having a particle dispersed therein (particle-containing composition) was produced using the composition for dispersing a particle of Example 1 obtained in [1] above, and the dispersability of the composition for dispersing a particle was evaluated through measurements and tests indicated below.

(3-1) Measurement of Zeta Potential (ζ Potential) and Results

(1) Preparation of Aluminum Oxide Suspension (Production of Particle-Containing Composition)

The composition for dispersing a particle of Example 1 (titanic acid concentration:2 mol/dm³), water, aluminum oxide powder (mean particle size:0.3 μm, purity:≧99.99%, product of Sumitomo Chemical Co., Ltd., trade name “AKP-30”), and a pH adjusting agent were mixed by a ball milling for 24 hours at room temperature (about 25° C.), to prepare aluminum oxide suspensions (aluminum oxide content: 2% by volume) having titanic acid concentrations of 1.0×10⁻³, 2.5×10⁻³, 5.0×10⁻³, 1.0×10⁻² and 1.0×10⁻¹ mol/dm³, and having pH in the range from about 2 to 12. For comparison, an aluminum oxide suspension (aluminum oxide content:2% by volume) which was not mixed with the composition for dispersing a particle was prepared as well.

As the aforementioned pH adjusting agent, nitric acid (HNO₃), ammonia (NH₃), or tetramethylammonium hydroxide (TMAOH) was used appropriately to set the prescribed pH. Additionally, when the pH was adjusted, pH electrode by a model “Orion 81-72 ROSS” manufactured by Orion Research was used.

(2) Measurement of Zeta Potential

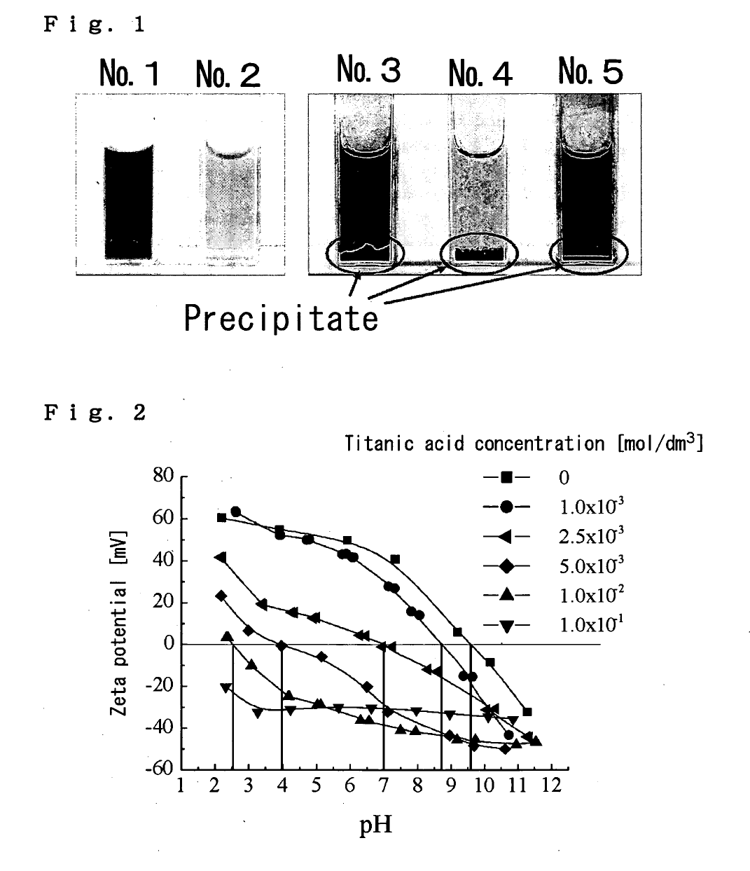

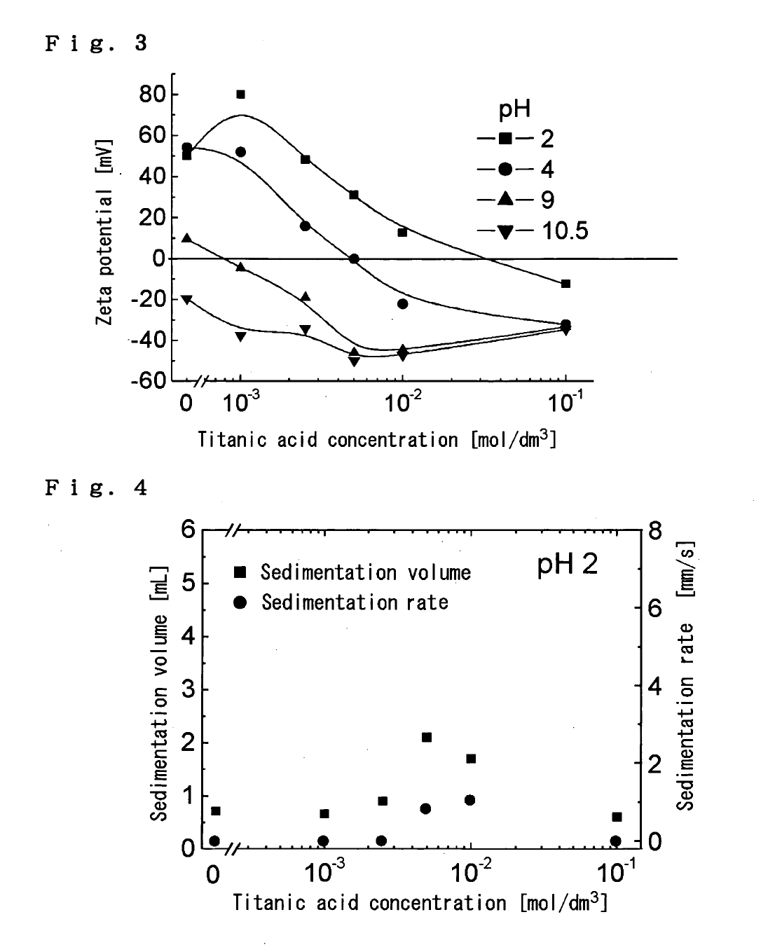

The zeta potential of each of the aluminum oxide suspensions prepared in (1) above was measured using ultrasonic ζ potential measurement device (product of Dispersion Technology, model “DT1200”). Results are given in FIGS. 2 and 3. Here, FIG. 2 shows the relationship between pH and zeta potential in a 2-vol % aluminum oxide suspension at various titanic acid concentrations. In addition, FIG. 3 shows the relationship between titanic acid concentration and zeta potential in 2-vol % aluminum oxide suspensions having various pHs.

(3) Results of Measurement of Zeta Potential

According to FIGS. 2 and 3, the isoelectric point of the aluminum oxide is close to pH of about 9 in the suspension having a titanic acid concentration of 0 mol/dm³, it is confirmed that the aluminum oxide surface has positive charge in pH region at the isoelectric point or below the isoelectric point (acidic side), and that the aluminum oxide surface has negative charge in pH region at the isoelectric point or above the isoelectric point (alkaline side).

Moreover, as shown in these figures, it was ascertained that when the titanic acid concentration in the composition for dispersing a particle to be mixed became higher, the isoelectric point of this aluminum oxide shifted to pH region on acidic side, i.e., the surface charge of the aluminum oxide shifts to negative side, and that when the titanic acid concentration was 1.0×10⁻¹ mol/dm³, the isoelectric point was no longer present.

From the above, it can be confirmed that a stable metal complex (titanium complex) having negative charge is present in this composition for dispersing a particle.

(3-2) Sedimentation Test and Results

(1) Preparation of Aluminum Oxide Suspension (Production of Particle-Containing Composition) and Sedimentation Test

Aluminum oxide suspensions (aluminum oxide content: 2% by volume) having titanic acid concentrations of 1.0×1⁻³, 2.5×10⁻³, 5.0×10⁻³, 1.0×10⁻² and 1.0×10⁻¹ mol/dm³, and having pHs of 2, 4 and 10.5, were prepared in the same manner as (3-1) described above. For comparison, an aluminum oxide suspension (aluminum oxide content: 2% by volume) which was not mixed with the composition for dispersing a particle was prepared as well.

(2) Sedimentation Test

10 mL of each of the aluminum oxide suspensions obtained in (1) above were transferred to and sealed in measuring cylinders, then left standing to carry out the sedimentation test. The sedimentation rate and sedimentation volume of the aluminum oxide particle in the suspensions having various titanic acid concentrations and pHs were measured. The results are shown in FIGS. 4 to 6. FIGS. 4 to 6 are ones showing the relationship between titanic acid concentration, sedimentation volume and sedimentation rate in 2-vol % aluminum oxide suspensions having pHs of 2, 4 and 10.5.

(3) Results of the Sedimentation Test

According to FIG. 4, the sedimentation rate was 0.1 mm/s or less and the sedimentation volume was 1 mL or less in the suspension having pH2 and at titanic acid concentrations in the range from 0 to 2.5×10⁻³ mol/dm³, so that good dispersion state was observed. At titanic acid concentrations of 5.0×10⁻³ mol/dm³ and 1.0×10⁻² mol/dm³, on the other hand, the sedimentation rate was in the range from about 0.8 to 1 mm/s and the sedimentation volume was in the range from about 1.8 to 2.2 mL, and a stable dispersion system was not obtained. This is because the positive surface charge of the aluminum oxide was neutralized in association with increasing titanic acid concentration, i.e., increasing negative charge. And it was confirmed that this phenomenon corresponded to the behavior at the time where zeta potentials were close to 0 (close to the isoelectric point at pH2) in the aforementioned FIGS. 2 and 3. Moreover, when the titanic acid concentration increased further to 1.0×10⁻¹ mol/dm³, the surface charge of the aluminum oxide shifted further to negative side, and the sedimentation rate therefore became 0.1 mm/s or less and the sedimentation volume became 1 mL or less, so that good dispersion state was again observed.

According to FIG. 5, when the titanic acid concentration was 5.0×10⁻³ mol/dm³, the sedimentation rate was about 1.6 mm/s and the sedimentation volume was about 2.3 mL, a stable dispersion was not obtained. At a titanic acid concentration out of this range, the sedimentation rate was 0.1 mm/s or less and the sedimentation volume was 1 mL or less, so that good dispersion state was observed. This indicates that positive surface charge of the aluminum oxide was neutralized in association with increasing titanic acid concentration to reduce dispersability in a temporary, after that the surface charge shifted further to negative side and a stable dispersion was obtained again, as is in the case at pH2 discussed previously. It was also confirmed that this phenomenon corresponded to the behavior at the time where zeta potentials were close to 0 (close to the isoelectric point at pH4) in the aforementioned FIGS. 2 and 3.

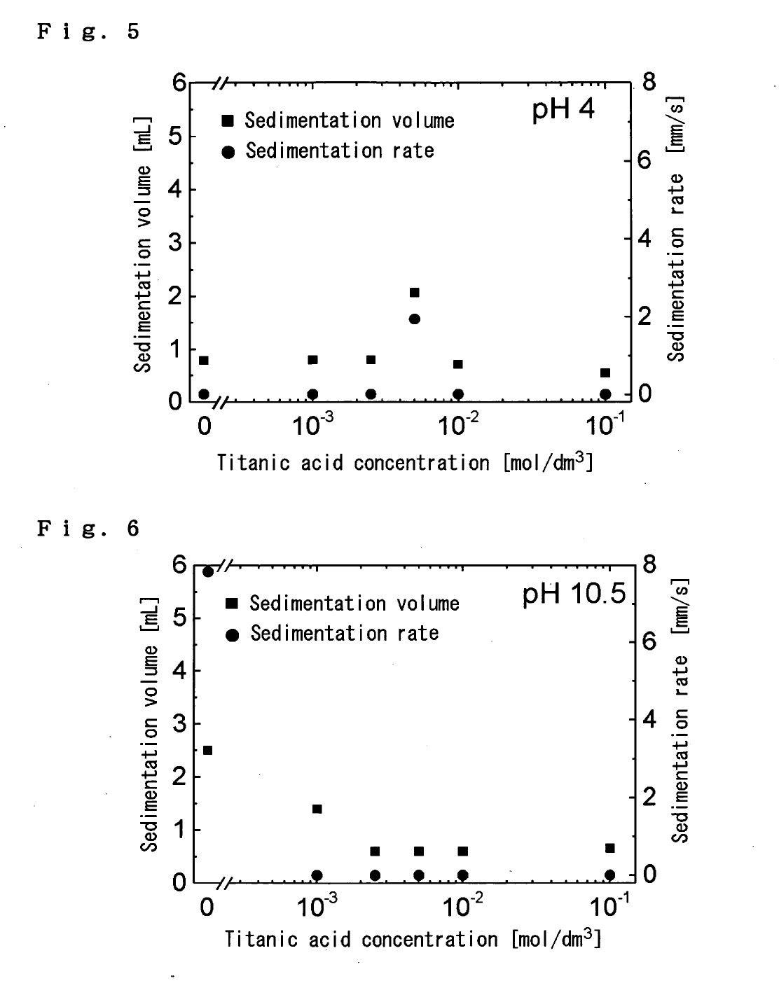

According to FIG. 6, in the suspension having pH10.5 where a composition for dispersing a particle was not incorporated, since the isoelectric point of the aluminum oxide particle was close to about pH9, the sedimentation rate was about 5.9 mm/s and the sedimentation volume was about 2.5 mL, and a stable dispersion was not obtained.

In contrast to this, when the composition for dispersing a particle was added, the surface charge was shifted to negative side, so that good dispersion state was observed. It was confirmed that this phenomenon corresponded to the behavior at the time where zeta potentials were close to 0 (close to the isoelectric point at pH10.5) in the aforementioned FIGS. 2 and 3.

From the above results, it was found that a stable dispersion can be obtained over a wide pH range when the titanic acid concentration, i.e., the amount of the composition for dispersing a particle to be mixed is controlled in accordance with the surface charge of the particle to be dispersed.

(3-3) Fluidity Behavior Test and Results

(1) Preparation of Aluminum Oxide Suspension (Production of Particle-Containing Composition)

Aluminum oxide suspensions (aluminum oxide content: 2 and 20% by volume) having titanic acid concentrations of 1.0×10⁻³, 2.5×10⁻³, 5.0×10⁻³, 1.0×10⁻², 2.5×10⁻², 5.0×10⁻², 7.5×10⁻² and 1.0×10⁻¹ mol/dm³, and having pHs of 4 and 10.5 were prepared in the same manner as (3-1) described previously. For comparison, aluminum oxide suspensions (aluminum oxide content: 2 and 20% by volume) which was not mixed with the composition for dispersing a particle were prepared as well.

(2) Fluidity Test

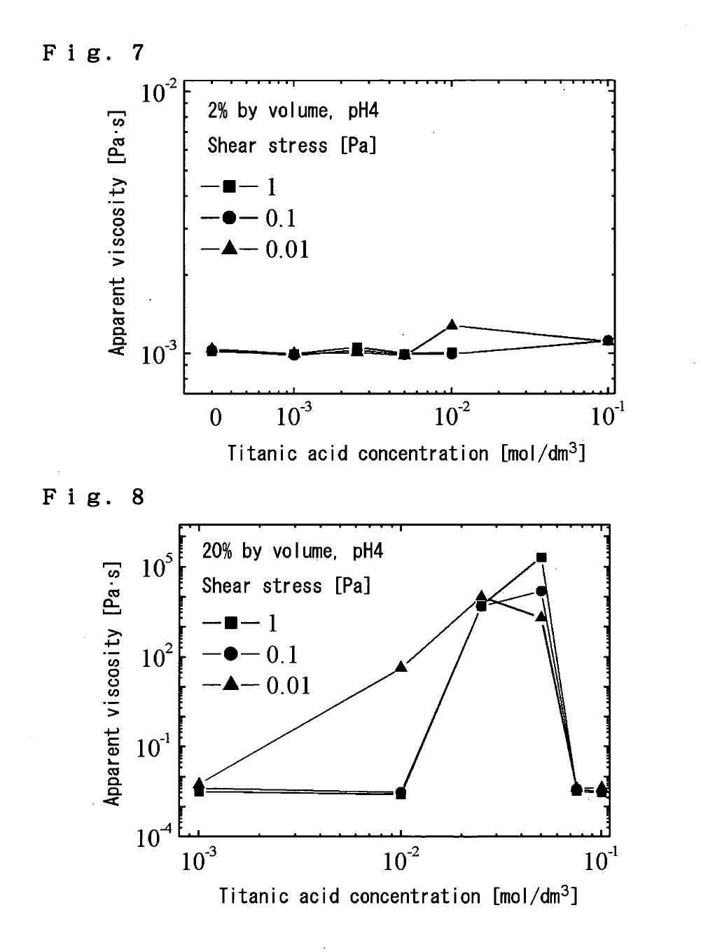

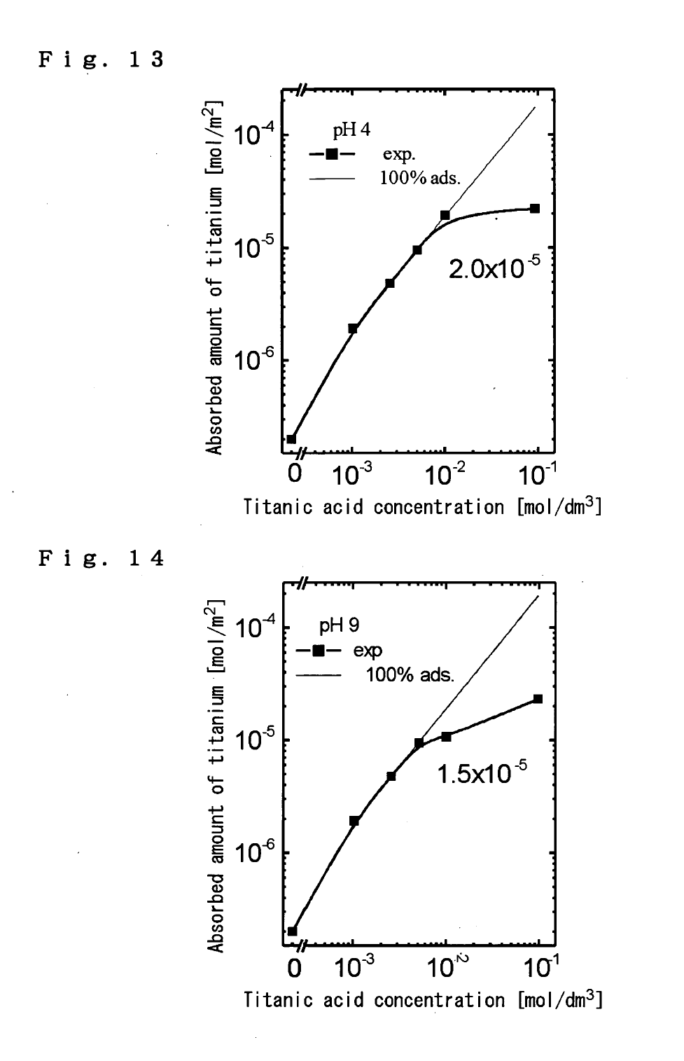

The apparent viscosity and the shear rate of the aluminum oxide suspensions obtained in (1) described previously were measured at 25° C. and at each of several shear stress levels using a rheometer (product of HAKKE, model “RS150”), and fluidity behavior was evaluated. Results are shown in FIGS. 7 to 12. FIGS. 7 to 10 show the relationship between titanic acid concentration and apparent viscosity at each of several shear stress levels for a 2-vol % aluminum oxide suspension having pH4, a 20-vol % aluminum oxide suspension having pH4, a 2-vol % aluminum oxide suspension having pH10.5 and a 20-vol % aluminum oxide suspension having pH10.5, respectively. In addition, FIGS. 11 and 12 show the relationship between shear stress and shear rate at each of several titanic acid concentrations for a 20-vol % aluminum oxide suspension having pH4 and a 20-vol % aluminum oxide suspension having pH10.5, respectively.

(3) Results of Fluidity Test

It was found that the effect of the titanic acid concentration in the case of using a 2-vol % aluminum oxide suspension having pH4 was not notable from FIG. 7, however, as shown in FIG. 8, when a suspension (pH4) whose content of aluminum oxide has been increased to 20% by volume was used, dispersability was lowered once but then again improved with further increasing titanic acid concentration. This phenomenon of lowered dispersability was due to the fact that positive surface charge of the aluminum oxide was neutralized in association with increasing negative charge. In order to disperse a desired particle in pH range lower (to acidic side) than the isoelectric point of the particle to be dispersed, it is necessary to mix the composition for dispersing a particle in an amount more than the amount to neutralize the surface charge of the particle. In this case, a particle-containing composition that contains a large amount of the metal component can be produced, and it is useful in a wide application for ceramic material, photocatalytic material, optical material, electronic material and the like.

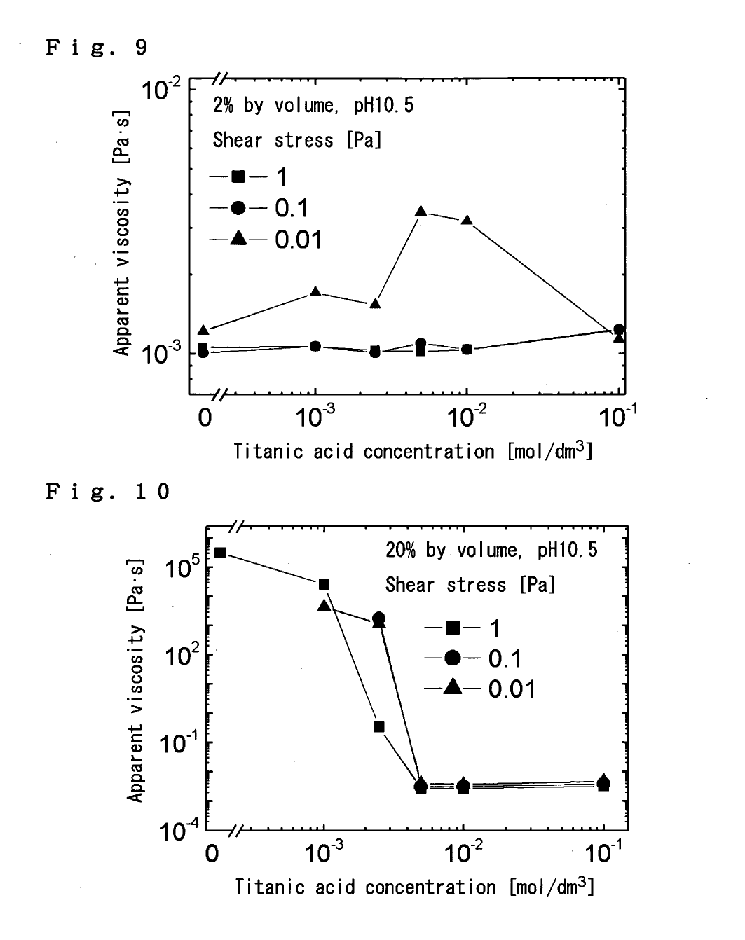

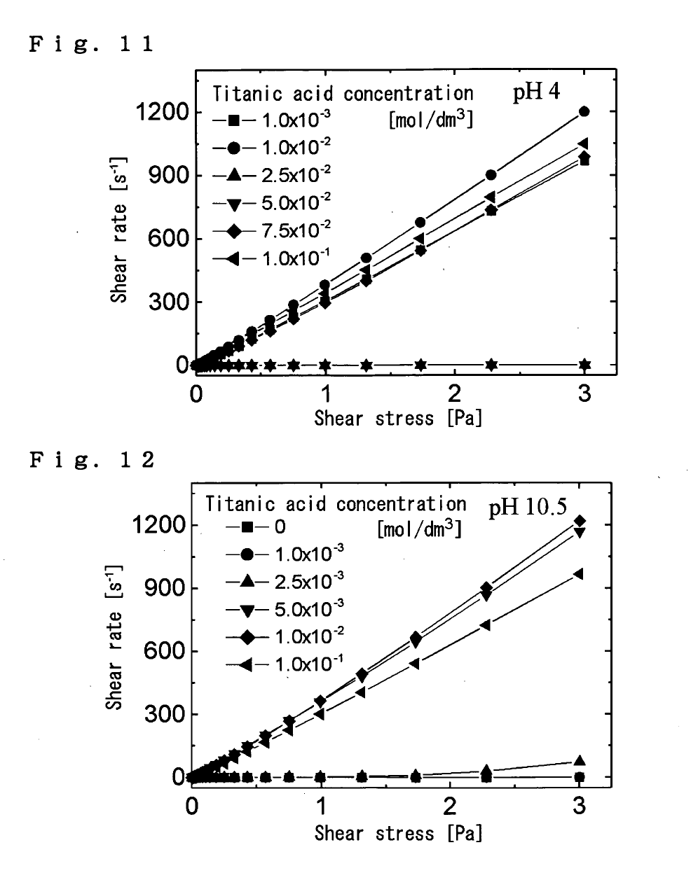

It was found that the effect of the titanic acid concentration in the case of using a 2-vol % aluminum oxide suspension having pH10.5 was not notable from FIG. 9, however, as shown in FIG. 10, when a suspension (pH10.5) whose content of aluminum oxide has been increased to 20% by volume was used, apparent viscosity reduced with increasing the titanic acid concentration, and that in the case of the concentration of higher than 5.0×10⁻³ mol/dm³, apparent viscosity reduced sharply to improve fluidity, and an excellent dispersion was obtained.

Based on the above, it was confirmed that, even if the content of the particle to be dispersed was higher in the case of using this composition for dispersing a particle, an excellent dispersion was obtained.

According to FIGS. 11 and 12, it was thought to be Newtonian fluid in the case of the 20-vol % aluminum oxide suspensions (pH4) having titanic acid concentrations of 1.0×10⁻³, 1.0×10⁻², 7.5×10⁻² and 1.0×10⁻¹ mol/dm³ in FIG. 11, and in the case of the 20-vol % aluminum oxide suspensions (pH10.5) having titanic acid concentrations of 5.0×10⁻³, 1.0×10⁻² and 1.0×10⁻¹ mol/dm³ in FIG. 12, since straight lines passed through the origin. And it was also confirmed that the straight lines have a large slope and that these dispersion had excellent fluidity and were extremely homogeneous.

(3-4) Measurement of Absorbed Amount and Results

(1) Preparation of Aluminum Oxide Suspension (Production of Particle-Containing Composition)

Aluminum oxide suspensions (aluminum oxide content: 2% by volume) having titanic acid concentrations of 1.0×10⁻³, 2.5×10⁻³, 5.0×10⁻², 1.0×10⁻², and 1.0×10⁻¹ mol/dm³, and having pHs of 4, 9 and 10.5 were prepared in the same manner as (3-1) described previously. For comparison, an aluminum oxide suspension (aluminum oxide content: 2% by volume) which was not mixed with the composition for dispersing a particle was prepared as well.

(2) Measurement of Absorbed Amount

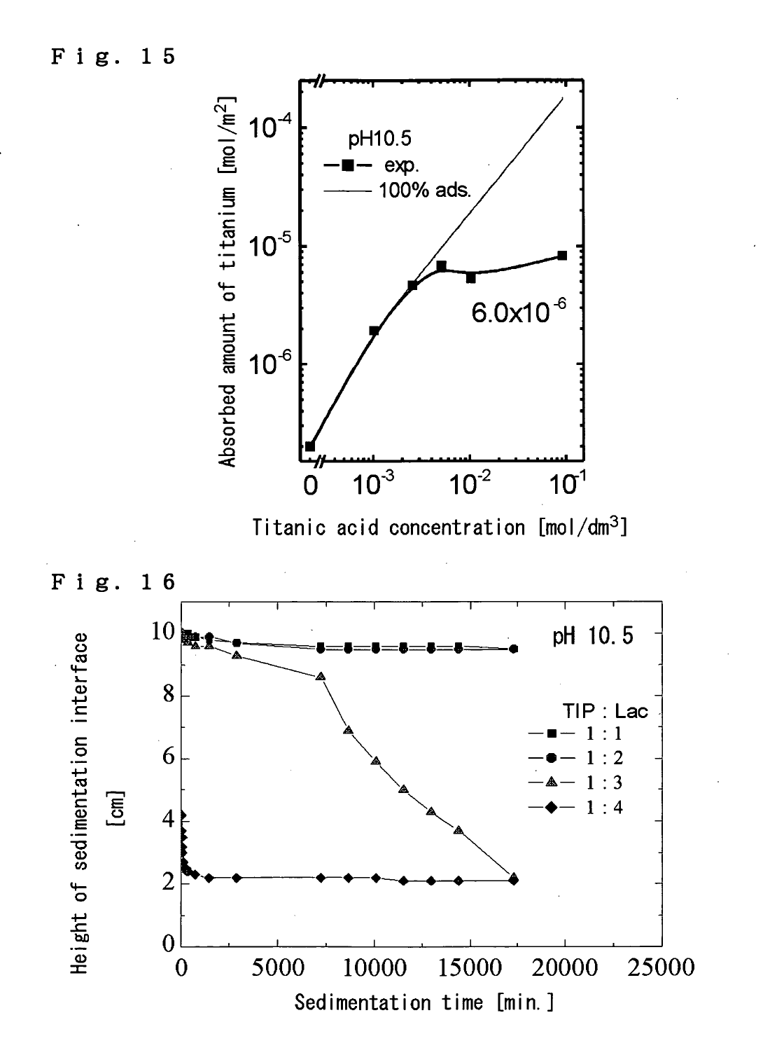

The aluminum oxide suspensions obtained in (1) described previously were subjected to centrifugal separation (maximum centrifugal force: 15,000 G). The absorbed amounts of titanium onto the aluminum oxide particle at each titanic acid concentration in the aluminum oxide suspensions were measured with an ICP-AES (product of Leeman Labs, Model “JICP-PS-1000UV-AT”) using the resultant supernatant. Results are shown in FIGS. 13 to 15. In FIGS. 13 to 15, the relationship between titanic acid concentration and absorbed amount of titanium in 2-vol % aluminum oxide suspensions having pHs of 4, 9 and 10.5, respectively are shown.

(3) Results of Measurement of Absorbed Amount

According to FIGS. 13 to 15, the absorbed amounts of titanium were 2.0×10⁻⁵ mol/m² at pH4, 1.5×10⁻⁵ mol/m² at pH9, and 6.0×10⁻⁶ mol/m² at pH10.5. This absorbed amount was reduced in association with change to alkaline side. Considering the surface charge at the titanic acid concentration of 0 mol/dm³ in FIG. 2, it would appear that since the surface charge of the aluminum oxide particle shifted to positive side in the region (acidic side) at isoelectric point or below the isoelectric point (close to pH9), the absorbed amounts of titanium increased on acidic side than alkaline side. From the fact, it is also thought that a metal complex having negative charge is present in the composition for dispersing a particle of the aforementioned Example 1.

[4] Dispersability of Composition for Dispersing a Particle (Effect of Molar Ratio Between Metal Alkoxide and Organic Acid)

Compositions for dispersing a particle were prepared in the same manner as in [1] described previously, except that molar ratio of titanium tetraisopropoxide to lactic acid was varied as indicated in [1] to [5] below in preparing. These compositions were then evaluated by the following test.

Molar ratio (titanium tetraisopropoxide:lactic acid) [1 ]1:1, [2] 1:2, [3] 1:3, [4] 1:4, [5] 1:0.4

In regard to the composition preparing at molar ratio 1:0.4 in [5] above, the hydrolysate failed to dissolve completely even with stirring for two weeks, and a composition for dispersing a particle could not be prepared. Consequently, the evaluations described below were carried out using the compositions for dispersing a particle of the molar ratios of [1] to [4] above.

(1) Preparation of Aluminum Oxide Suspension (Production of Particle-Containing Composition)

The compositions for dispersing a particle having each molar ratio (titanic acid concentration:2 mol/dm³), water, aluminum oxide powder (mean particle size:0.3 μm, purity:≧99.99%, product of Sumitomo Chemical Co., Ltd., trade name: “AKP-30”), and a pH adjusting agent were mixed by ball milling at room temperature (about 25° C.) for 24 hours, to prepare aluminum oxide suspensions (aluminum oxide content: 2% by volume) having a titanic acid concentration of 1.0×10⁻² mol/dm³ and having pHs of 2 and 10.5. At the time that the suspensions were being prepared, the aluminum oxide particles did not sedimentate and remained sufficiently dispersed.

The same pH adjusting agents as those mentioned previously were used in an appropriate manner. The pH electrode used during pH modification was similar to that mentioned previously.

(2) Sedimentation Test

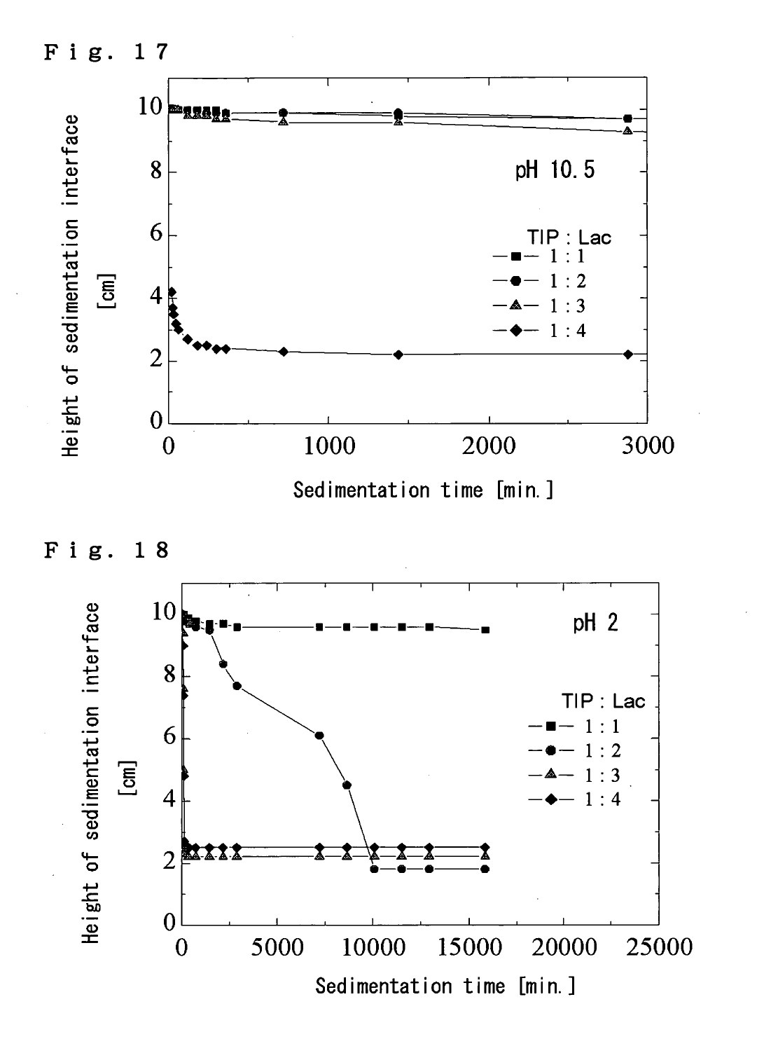

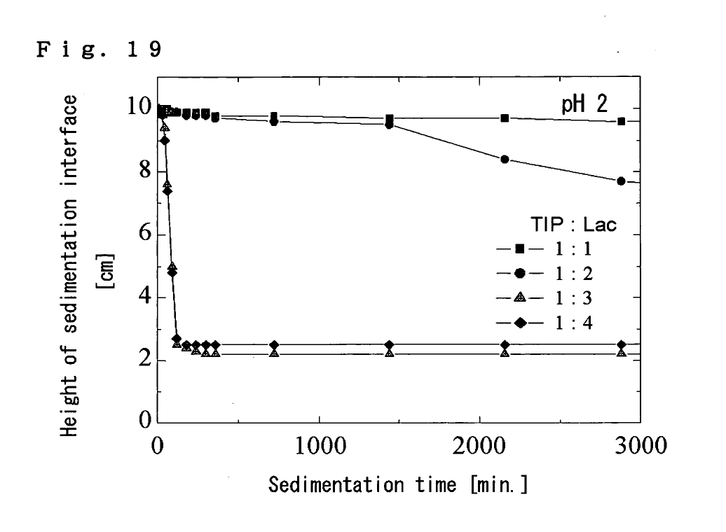

10 mL of each of the aluminum oxide suspensions obtained in (1) above were transferred to and sealed in measuring cylinders, then left standing to carry out the sedimentation test. The sedimentation times of the aluminum oxide particle in the suspensions having various molar ratios and pHs were measured. The results are shown in FIGS. 16 to 19. Here, FIG. 16 shows the change in dispersability when the ratio of titanium alkoxide to lactic acid was varied in a 2-vol % aluminum oxide suspension having pH10.5 (sedimentation time: 0 to 17,500 minutes). FIG. 17 shows the change in dispersability when the ratio of titanium alkoxide to lactic acid was varied in a 2-vol % aluminum oxide suspension having pH10.5 (sedimentation time: 0 to 2,900 minutes). FIG. 18 shows the change in dispersability when the ratio of titanium alkoxide to lactic acid was varied in a 2-vol % aluminum oxide suspension having pH2 (sedimentation time: 0 to 16,000 minutes). FIG. 19 shows the change in dispersability when the ratio of titanium alkoxide to lactic acid was varied in a 2-vol % aluminum oxide suspension having pH2 (sedimentation time: 0 to 2,900 minutes). In FIGS. 16 to 19, “TIP” denotes titanium tetraisopropoxide, and “Lac” denotes lactic acid.

(3) Results

According to FIGS. 16 and 17, it was found that the suspensions in which titanium alkoxide to lactic acid ratios were 1:2 and 1:1, indicated excellent dispersability over a long period in the case of pH10.5, because sedimentation of aluminum oxide particle was very slight until 17,500 minutes had passed, and the height of sedimentation interface was substantially constant. Additionally, in regard to the suspension in which titanium alkoxide to lactic acid ratio was 1:3, there was only very slight aluminum oxide particle sedimentation until 7,500 minutes had passed, with sedimentation of particles gradually beginning thereafter, but it was apparent that dispersability was excellent over a long period. Further, in the suspension in which titanium alkoxide to lactic acid ratio was 1:4, particles sedimented in a short time, but it was apparent that dispersability was sufficient for a short time period after preparation.

According to FIGS. 18 and 19, it was found that the suspension in which titanium alkoxide to lactic acid ratio was 1:1, indicated excellent dispersability over a long period in the case of pH2, because sedimentation of aluminum oxide particle was very slight until 16,000 minutes had passed, and the height of sedimentation interface was substantially constant. Additionally, in regard to the suspension in which titanium alkoxide to lactic acid ratio was 1:2, there was only very slight aluminum oxide particle sedimentation until 2,500 minutes had passed, with sedimentation of particles gradually beginning thereafter, but it was apparent that dispersability was excellent over a long period. Further, in the suspensions in which titanium alkoxide to lactic acid ratios were 1:3 and 1:4, particles in both sedimented in a short time, but it was apparent that dispersability was sufficient for a short time period after preparation.

When all of the suspensions having the sedimentated were stirred, a state where particles are sufficiently dispersed was obtained, which was the same as in preparing.

From the above, it was found that the smaller ratio of lactic acid against titanium alkoxide was, the more improved dispersability was obtained and the longer the effects could be sustained.

[5] Effects of Examples

Judging from the situation, it is considered that a stable metal complex that was formed by a metal ion and an organic acid, and that had high bulk and negative charge, is present in the composition for dispersing a particle of the present invention. According to this composition for dispersing a particle, a homogeneous and stable dispersion (particle-containing composition) can be readily produced by adjusting the amount of the composition for dispersing a particle to be mixed in consideration of the isoelectric point of particle to be dispersed.

The phenomenon displayed by this composition for dispersing a particle is very similar to the pH behavior observed when an anionic polymer electrolyte is added as a dispersing agent, and it is surprising that particles disperse without aggregation in the presence of a metal ion having high positive charge (titanium ions in Examples). Further, the effectiveness of the composition as a dispersing agent is the same as or better than that of the polymer electrolyte reported to date, and the suspension functioning as a dispersing agent has very wide pH ranging from 2 to 11 and the range of mixable amounts is broad. Moreover, since other components such as halogens, nitric acid and sulfuric acid are not contained, there is no impact on the environment when the composition undergoes the sintering process. And since the composition is an aqueous solution, risk of fire and the like is absent, and safety is excellent.

### INDUSTRIAL APPLICABILITY

This composition for dispersing a particle is useful in a wide application for ceramic material, photocatalytic material (for wastewater treatment, deodorizing, decolorization, sterilization, photosensitizing agents, etc.), optical material, electronic material such as dielectric material (barium titanate, potassium titanyl phosphate, etc.), and the like. In particular, the composition is suitable for use in an application for photocatalytic material, or solar cell material such as dye sensitized solar cell.

In addition, the composition can not only be used as a dispersing agent for a particle, but also be used in an effective method for uniform doping a metal element to the primary component. Since this composition for dispersing a particle is an aqueous solution, it is possible to combine the composition with other water-soluble compounds, improving the range of synthesis of materials.

1. A composition for dispersing of a particle, characterized in being obtained by mixing a metal alkoxide containing a metal element having +3 to 5 valence, an organic acid and water.

2. The composition for dispersing of a particle according to claim 1, which is obtained by mixing a hydrolysate derived from said metal alkoxide, and said organic acid, and which is a transparent aqueous solution.

3. The composition for dispersing of a particle according to claim 1, wherein said metal element is one element selected from the group consisting of aluminum, titanium, niobium and tantalum.

4. The composition for dispersing of a particle according to claim 1, wherein said metal element is aluminum or titanium.

5. The composition for dispersing of a particle according to claim 1, wherein said organic acid is at least one type selected from the group consisting of lactic acid, oxalic acid, citric acid and tartaric acid.

6. The composition for dispersing of a particle according to claim 1, wherein the mixing proportion of said organic acid and said metal alkoxide (organic acid:metal alkoxide), is (0.5-2):1 by molar ratio.

7. A composition for dispersing of a particle, characterized in that said composition is obtained by mixing a titanium alkoxide, at least one type of an organic acid selected from the group consisting of lactic acid, oxalic acid, citric acid and tartaric acid, and water; and that the mixing proportion of said titanium alkoxide and said organic acid (organic acid:titanium alkoxide), is (0.7-1.5):1 by molar ratio.

8. A composition having a particle dispersed therein, characterized in comprising a particle and said composition for dispersing of a particle according to claim 1.

9. The composition having a particle dispersed therein according to 8, wherein said particle is an oxide particle.

10. The composition having a particle dispersed therein according to claim 8, wherein the content of said particles is 60% by volume or less.

11. The composition having a particle dispersed therein according to claim 8, wherein pH is in the range from 2 to 11.

12. The composition having a particle dispersed therein according to claim 8, which is used in an application for ceramic material, photocatalytic material, optical material or electronic material.

13. A composition having a particle dispersed therein, characterized in comprising an anatase-type titanium oxide particle and said composition for dispersing of a particle according to claim 7.

14. A sintered compact of anatase-type titanium oxide, characterized in that the solid fraction of said composition having a particle dispersed therein according to claim 13 is sintered.

15. The sintered compact of anatase-type titanium oxide according to claim 14, wherein the sintering temperature is in the range from 300 to 750° C.

16. The sintered compact of anatase-type titanium oxide according to claim 14, which is used in an application for photocatalytic material or solar cell material.

17. A process for producing a composition having a particle dispersed therein, characterized in that said process comprises a mixing step for mixing said composition for dispersing of a particle according to claim 1, a particle and a solvent, and that the amount of said composition to be mixed is adjusted depending on the isoelectric point of said particle in said mixing step.

18. The process for producing a composition having a particle dispersed therein according to claim 17, wherein said solvent is water.
